(19) United States
(12) Patent Application Publication
(10) Pub. No.: US 2007/0151460 A1
(43) Pub. Date: Jul. 5, 2007

(54) Flavored filters

(76) Inventor: Darryn Beck, Bluffton, SC (US)

Correspondence Address: Galasso & Associates, LP, P.O.Box 26503, Austin, TX, 78755-0503, US

(21) Appl. No.: 11/322,046

(22) Filed: Dec. 29, 2005

(51) Int. Cl. A47J 31/00

(52) U.S. Cl. 99/279

(57) ABSTRACT

A flavored filter is provided for making coffee or tea with a desired flavor. The filter is similar to standard coffee filters used in coffee makers, but is impregnated with flavoring suitable for beverages such as coffee and tea. The filter may be impregnated with a flavoring by drying the flavoring into the filter paper, for example in a mixture with gelatin. Or the filter may comprise top and bottom layers, so that the flavoring may be placed in the bottom layer and the coffee or tea in the top. The filter is placed in a holder in a coffee or tea maker, and coffee or tea is added to the filter. Hot water from the coffee or tea maker, or poured by hand, causes the coffee or tea and the flavoring to mix as the water pushes through the filter.

### FIELD OF THE DISCLOSURE

The present invention relates generally to filters for making coffee or tea, and more particularly to filters that impart desired flavors to coffee or tea.

### BACKGROUND

Fiber filters of many designs are used to make coffee or tea conveniently. Typically a paper filter is placed in a supporting holder or cup, coffee or tea is placed inside the filter, either as loose grounds or leaves or contained in a fiber bag, and hot water is poured over the filter. The coffee or tea brewed in this way has the flavor of the coffee grounds or tea placed in the filters. To provide coffee or tea in a special flavor, coffee grounds or tea that has that flavor must be placed in a filter. To provide coffee with a vanilla flavor, for example, coffee grounds that have already been prepared to have a vanilla flavor must be placed in a filter and then brewed. A wide range of flavored coffees and teas are available to meet the tastes of different consumers, and often these are marketed as expensive, gourmet items. Additional flavoring, such as creamer or sugar, is usually added after the coffee or tea has been brewed.

Users often want to quickly make coffee or tea in many different flavors. For example, home consumers may want to entertain many guests who drink different flavors of coffee or tea. Similarly, restaurants and hotels may want to provide coffee or tea in many different flavors for their guests. However, it may be expensive to purchase coffee or tea in many different flavors, especially at gourmet prices, and it may be difficult to find the space to store them. Moreover, the overall process of manufacturing, marketing, purchasing, and brewing flavored coffees and teas is time consuming.

Therefore, there is a need for a method to brew flavored coffees and teas that is inexpensive, fast, and reduces required storage space.

### SUMMARY OF THE DISCLOSURE

The following explanation describes the present invention by way of example and not by way of limitation.

It is an aspect of the present invention to provide a method to brew flavored coffee and tea by means of flavored filters.

It is another aspect of the present invention to provide an inexpensive method to brew flavored coffee and tea.

It is yet another aspect of the present invention to provide a fast method to brew flavored coffee and tea.

It is still another aspect of the present invention to provide a method to brew flavored coffee and tea that reduces storage requirements.

These and other aspects of the present invention will become readily apparent upon further review of the following specification and associated drawings. In accordance with the present invention, a flavored filter is provided for making coffee or tea with a desired flavor. The filter is similar to standard coffee filters used in coffee makers, but is impregnated with flavoring suitable for beverages such as coffee and tea. The filter may be impregnated with a flavoring by drying the flavoring into the filter paper, for example in a mixture with gelatin. Or the filter may comprise top and bottom layers, so that the flavoring may be placed in the bottom layer and the coffee or tea in the top. The filter is placed in a holder in a coffee or tea maker, and coffee or tea is added to the filter. Hot water from the coffee or tea maker, or poured by hand, causes the coffee or tea and the flavoring to mix as the water pushes through the filter.

### BRIEF DESCRIPTION OF THE DRAWINGS

The following embodiments of the present invention are described by way of example only, with reference to the accompanying drawings, in which:

FIG. 1 is a perspective diagram of a flavored filter for making flavored coffee or tea.

FIG. 2 is a side view of a flavored filter with the flavoring and coffee grounds or tea in place.

FIG. 3 is a side view of a flavored filter with two filter layers.

### DETAILED DESCRIPTION OF THE DRAWING FIGURES.

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

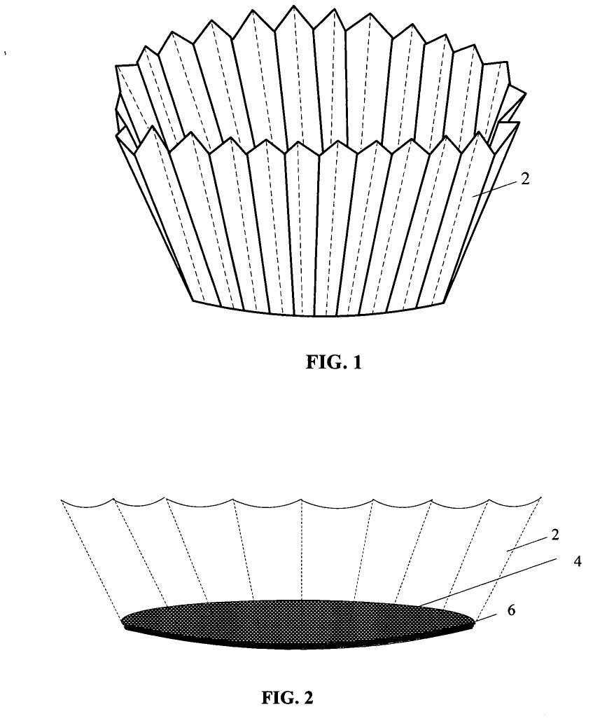

The present invention comprises flavored fiber filters used to brew flavored coffee or tea or other beverages. In an embodiment shown in FIG. 1, the filter 2 is manufactured of paper that is similar in form and function to that currently being used in the production of standard coffee filters used with coffee makers. The paper should be durable but permeable, so that water can easily seep through without causing the filter to break down. The filter comprises a bowl-like design with fluted sides, so that the filter can easily accommodate the shape of a coffee or tea maker's filter holder. In different embodiment, the filter may comprise different sizes to enable it to be adapted for use with a large number of coffee and tea makers.

FIG. 2 shows how the flavoring 6 and coffee or tea 4 are placed in a flavored filter 2. The base of the filter is impregnated with a dried form of flavoring 6 suitable for beverages such as coffee and tea. These flavorings may include, but are not limited to, vanilla, amaretto, and mocha, as well as common coffee and tea enhancers, such as milk and creamers. In embodiments, these flavorings may be used in dried syrup, sugar, powder, and extract forms. Blended flavors may also be provided, for example vanilla-hazelnut and chocolate-marshmallow for coffee and lemon-orange for tea. The coffee grounds or tea 4 are placed on top of the flavoring 6.

In an embodiment, the filter may be impregnated with a flavoring by drying the flavoring into the filter paper. To provide a vanilla-flavored filed, for example, vanilla flavoring may be added to a gelatin base. The filter may be soaked in the vanilla and gelatin mixture and then dried in an oven or by means of hot air.

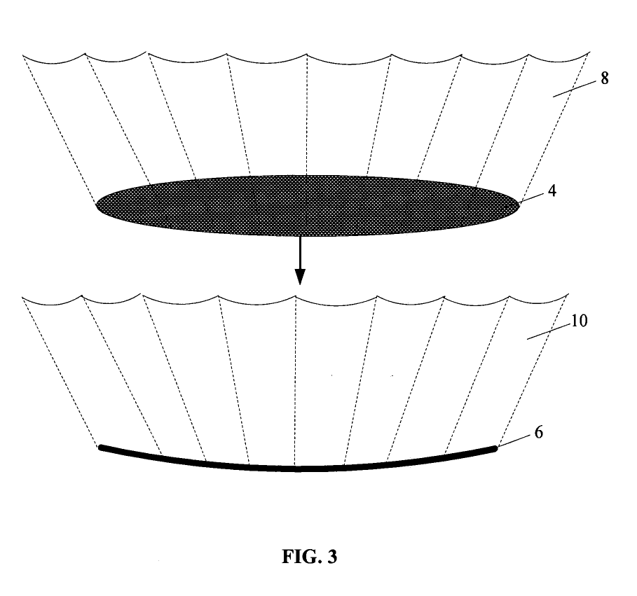

In another embodiment, shown in FIG. 3, the filter may comprise two paper layers, so that a top layer 8 fits into a bottom layer 10. Powdered flavoring 6 may be placed in the bottom of the bottom layer 10, and the top layer 8 may then be placed on top of the bottom layer 10. Subsequently coffee grounds or tea 4 may be placed in the top layer 8. For example, powdered vanilla 6 may be spread over the bottom of the bottom layer 10, and coffee 4 may be placed in the bottom of the top layer 8.

In an embodiment, the flavored filters may be manufactured in colors designed to match different flavors. For example, a filter may be manufactured in a chocolate color to indicate that it has a chocolate flavor.

In different embodiments, filters may be provided in single-flavor packages, such as vanilla, or in variety packages, for example containing separate filters with vanilla, chocolate, and amaretto flavorings.

The best dimensional relationships for the parts of the invention described above, including variations in form and use, will be readily apparent to those skilled in the art, and are intended to be encompassed by the present invention.

Use

A user obtains a filter with the desired flavor, inserts the flavored filter into the holder in a coffee or tea pot in the traditional manner, and places a measured amount of the coffee grounds or tea into the filter. Hot water dispensed from the coffee or tea maker, or poured by hand, into the flavored filter causes the coffee or tea and the impregnated flavoring in the filter to mix as the water pushes through the filter and into the coffeepot or teapot.

The user thus quickly creates a flavored coffee or tea that may be of gourmet quality, without the effort or expense previously required to purchase a separate coffee or tea for each desired flavor at expensive gourmet prices. Moreover, the user does not need to store bulky containers of coffee or tea in different flavors, but only lightweight and compact packages of filters.

Subsequently the flavored filter may be removed from the pot and discarded.

What is claimed is:

1. A flavored filter for making coffee or tea with a desired flavor, the flavored filter comprising
a fiber filter impregnated with a desired flavoring, and
a standard filter design for coffee makers or tea makers, such that the flavored filter may be placed in a holder in the coffee maker or tea maker,
coffee grounds or tea may be placed in the filter,
water may be dispensed from the coffee maker or tea maker, or poured by hand, over the flavored filter, and
the coffee or tea and the flavoring in the filter mix as the water pushes through the filter, such that the brewed coffee or tea takes on the flavoring in the filter.

2. The fiber filter impregnated with flavoring of claim 1, wherein the fiber filter impregnated with flavoring is manufactured of paper.

3. The fiber filter impregnated with flavoring of claim 1, wherein the fiber filter is impregnated with flavoring by the method of drying the flavoring into the filter.

4. The method of drying the flavoring into the filter of claim 3, wherein the method of drying the flavoring into the filter comprises
mixing the flavoring with a gelatin base,
soaking the filter in the mixture of flavoring and gelatin, and
drying the filter.

5. The drying the filter of claim 4, wherein the drying the filter comprises drying the filter in an oven.

6. The drying the filter of claim 4, wherein the drying the filter comprises drying the filter by means of hot air.

7. The fiber filter impregnated with flavoring of claim 1, wherein the fiber filter is impregnated with flavoring by means of the filter comprising two layers, such that
a top layer fits into a bottom layer,
powdered flavoring may be placed in the bottom layer, and
coffee grounds or tea may be placed in the top layer.

8. The fiber filter impregnated with flavoring of claim 1, wherein the fiber filter impregnated with flavoring is manufactured in a color designed to match the flavoring.

9. A flavored filter for making coffee or tea with a desired flavor, the flavored filter comprising
a paper filter impregnated with a desired flavoring by the method of drying the flavoring into the filter paper, and
a standard filter design for coffee makers or tea makers, such that
the flavored filter may be placed in a holder in the coffee maker or tea maker,
coffee grounds or tea may be placed in the filter,
water may be dispensed from the coffee maker or tea maker, or poured by hand, over the flavored filter, and
the coffee or tea and the flavoring in the filter mix as the water pushes through the filter, such that the brewed coffee or tea takes on the flavoring in the filter.

10. The method of drying the flavoring into the filter paper of claim 9, wherein the method of drying the flavoring into the filter paper comprises
mixing the flavoring with a gelatin base,
soaking the filter in the mixture of flavoring and gelatin, and drying the filter.

11. The drying the filter of claim 10, wherein the drying the filter comprises drying the filter in an oven.

12. The drying the filter of claim 10, wherein the drying the filter comprises drying the filter by means of hot air.

13. The paper filter impregnated with flavoring of claim 9, wherein the fiber filter impregnated with flavoring is manufactured in a color designed to match the flavoring.

14. A flavored filter for making coffee or tea with a desired flavor, the flavored filter comprising
a paper filter impregnated with a desired flavoring by means of the filter comprising two layers, such that
a top layer fits into a bottom layer,
powdered flavoring may be placed in the bottom layer, and
coffee grounds or tea may be placed in the top layer; and
a standard filter design for coffee makers or tea makers, such that the flavored filter may be placed in a holder in the coffee maker or tea maker,
coffee grounds or tea may be placed in the filter,
water may be dispensed from the coffee maker or tea maker, or poured by hand, over the flavored filter, and
the coffee or tea and the flavoring in the filter mix as the water pushes through the filter, such that the brewed coffee or tea takes on the flavoring in the filter.

15. The paper filter impregnated with flavoring of claim 14, wherein the paper filter impregnated with flavoring is manufactured in a color designed to match the flavoring.
